(19) United States
(12) Patent Application Publication
(10) Pub. No.: US 2026/0180675 A1
(43) Pub. Date: Jun. 25, 2026

(54) SYSTEM AND METHOD FOR INTERFACING GROUND BASED BEAMFORMER (GBBF) AND 5G RAN FOR NTN

(71) Applicant: Hughes Network Systems, LLC, Germantown, MD (US)

(72) Inventors: James Jehong Jong, North Potomac, MD (US); Mostafa Tarrah, Oakton, VA (US)

(21) Appl. No.: 19/000,921

(22) Filed: Dec. 24, 2024

(51) Int. Cl. H04B 7/185

(52) U.S. Cl. CPC H04B 7/18539; H04B 7/18513; H04B 7/18517; H04B 7/1855

(57) ABSTRACT

Techniques are described for facilitating communications between multiple tenants of a terrestrial network and a satellite ground-based beamforming (GBBF) system. The system includes a multi-tenant interface controller (MTIC) that multiplexes tenant streams, converts them to a beam sample rate, and communicates them to the GBBF system for satellite beamforming. Embodiments of the MTIC support multiple stream types and can employ synchronization techniques, including GPS-locked clocks and fractional Doppler compensators, to maintain signal integrity. A resource manager can dynamically allocate frequency resources to optimize performance.

### BACKGROUND

Satellite communication systems are increasingly being deployed for global connectivity, including in remote areas. Some such systems include multi-beam technology to enhance capacity and efficiency. Some multi-beam technologies use beamforming to produce, shape, point, and/or otherwise control the multiple beams. Beamforming is typically performed onboard the satellite, but some systems have employed ground-based beamforming (GBBF) particularly with bent-pipe satellites. To date, GBBF has been successfully deployed in limited satellite-only systems, but it is incompatible with satellite non-terrestrial network (NTN) extensions to terrestrial (e.g., cellular) networks.

### BRIEF SUMMARY

Methods and systems are described for facilitating communications between multiple tenants of a terrestrial network and a satellite ground-based beamforming (GBBF) system. Embodiments include a multi-tenant interface controller (MTIC) that interfaces between multiple tenants' 5G New Radio (NR) networks and a GBBF system. The MTIC aggregates and multiplexes tenant streams, converts them to a predefined beam sample rate (BSR), and communicates the resulting beam streams to the GBBF system, which then forms multiple satellite beams. The MTIC can support different stream types, including wideband, narrowband, and very-narrow-band streams, each having distinct sample rates. Embodiments employ advanced synchronization techniques, including GPS-locked clocks and fractional Doppler compensators, to ensure precise timing and signal integrity. Embodiments also include a resource manager to allocate and manage frequency resources dynamically.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows an illustrative communication system including a terrestrial network with a multi-beam satellite-based non-terrestrial network (NTN) extension, according to embodiments described herein.

FIG. 2 shows an example of a resource block allocation for a wideband stream type.

FIG. 3 shows an example of a resource block allocation for a narrow-band stream type.

FIG. 4 shows an example of a resource block allocation for a very-narrow-band stream type.

FIG. 5 shows an example of a multi-tenant resource block allocation that includes multiple stream types facilitated by an multi-tenant interface controller (MTIC).

FIGS. 6 and 7 show forward-link and return-link portions, respectively, of a partial architecture having an illustrative MTIC disposed between tenants and a satellite ground-based beamforming (GBBF) system, according to embodiments described herein.

FIG. 8 shows an illustrative communication system including a terrestrial network with a multi-beam satellite-based non-terrestrial network (NTN) extension, according to embodiments described herein.

FIG. 9 provides a schematic illustration of an embodiment of a computational system that can implement various system components and/or perform various steps of methods provided by various embodiments.

FIG. 10 shows a flow diagram of a method for facilitating communications between a plurality of tenants of a terrestrial network and a satellite ground-based beamforming (GBBF) system, according to embodiments described herein.

### DETAILED DESCRIPTION

Some satellite communication systems use multi-beam technology, which allows satellites to cover larger areas with multiple focused beams, thereby enhancing capacity and spectral efficiency. Multi-beam satellites can generally be categorized into two types: regenerative (or “processing”) satellites and bent-pipe (or “transparent”) satellites. Regenerative satellites include onboard processing capabilities that can demodulate, process, and re-modulate signals before transmitting them back to Earth. For example, this allows for signal regeneration, error correction, and potentially more efficient use of available bandwidth. In contrast, bent-pipe satellites simply relay the received signals from one ground station to another without any onboard processing.

Multi-beam capabilities can be provided by a beamformer, which is responsible for shaping and directing the beams to specific geographical areas, thereby optimizing signal strength and coverage. For example, the beamformer manipulates phases and amplitudes of signals transmitted or received by the satellite's antenna elements. These antenna elements are arranged in a phased-array configuration, which consists of multiple small antennas working together to form a single, larger antenna pattern. In effect, the beamformer uses complex algorithms to adjust the phases and amplitudes of the signals across the array, creating constructive and destructive interference patterns that effectively steer the beams in desired directions (“electronic beam steering”). In this way, a satellite can dynamically and rapidly focus multiple beams on different regions without physically moving the antenna or its antenna elements.

Traditionally, beamformers are located on the satellite itself. However, it can be desirable in certain cases to deploy one or more ground-based beamformer (GBBF) systems, whereby beamforming components and capabilities are relocated from the satellite(s) to ground station(s). For example, GBBF systems can be used to provide multi-beam capabilities to bent-pipe satellite systems. GBBF can provide several features. For example, performing beamforming on the ground can allow operators to achieve rapid, adaptable, and flexible beamforming capabilities. GBBF also allows for easier updates and maintenance, reducing the complexity and cost of the satellite payload; and GBBF can be implemented with more advanced and powerful processing equipment that may not be feasible to deploy onboard the satellite, due to size, weight, and power constraints.

However, the use of GBBF introduces several technical challenges, including concerning standardization and compatibility with existing communication protocols. Some modern communication networks are being designed and implemented based on current 3rd Generation Partnership Project (3GPP) fifth-generation (5G) New Radio (NR) Non-Terrestrial Network (NTN) specifications and standards. Presently, 3GPP 5G NR/NTN specifications and standards neither address nor include support for GBBF. In particular, legacy GBBF hardware and waveform protocols tend to be proprietary and not directly compatible with the 3GPP 5G NR/NTN air interface specification. Such incompatibility can prevent a legacy GBBF-based system from directly interfacing with a 3GPP 5G-based Radio Access Node (RAN), which connects individual devices to a core network.

Furthermore, some communication service providers desire to provide concurrent services to different 5G operators, or “tenants.” This can add another layer of technical complexity to using GBBF, as successful deployment can rely on being able to use the same GBBF-based systems concurrently for different tenants. For example, each tenant may have a specific service profile, which can define distinct data requirements, service level agreements, configuration parameters, and the like. Concurrent handling of these different service profiles can involve sophisticated management and coordination across operators to ensure that all operators can meet any requirements of the service profiles without interference.

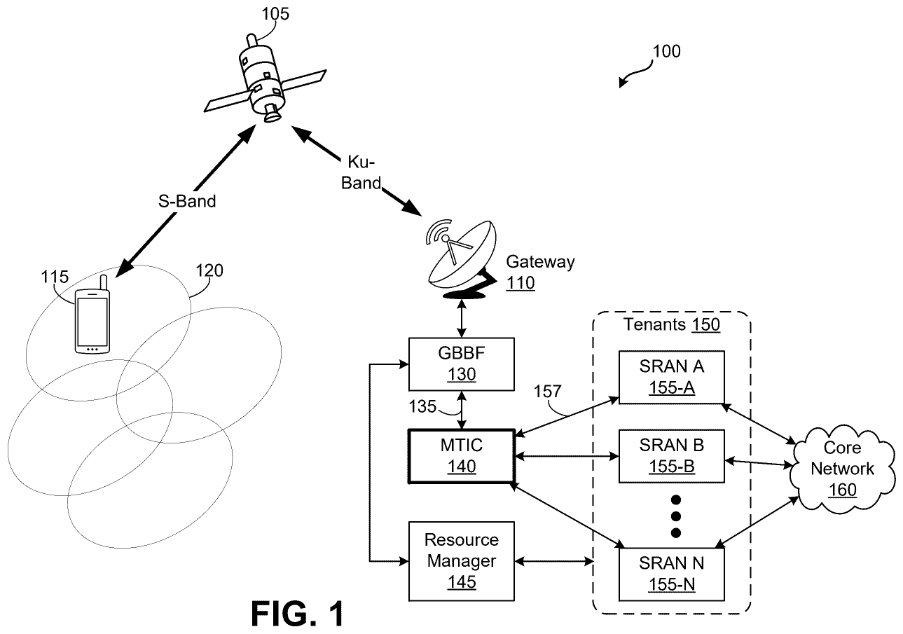

FIG. 1 shows an illustrative communication system 100 including a terrestrial network with a multi-beam satellite-based non-terrestrial network (NTN) extension, according to embodiments described herein. At a high level, the communication system 100 provides connectivity between a core network 160 and multiple user terminals 115, thereby facilitating provision by multiple tenants 150 (network operators) of communication services to the user terminals 115. As described in detail herein, the communication system 100 includes a multi-tenant interface controller (MTIC) 140, which acts as an intermediary between the multiple tenants' 150 5G NR networks (SRANs 155) and a GBBF system 130.

The GBBF system 130 is in communication with one or more 3GPP 5G NR/NTN air interfaces. Each 3GPP 5G NR/NTN air interface includes one or more gateway terminals 110 in communication with user terminals 115 via one or more satellites 105. Each gateway terminal 110 is a high-capacity radio frequency (RF) terminal located on the ground. In the illustrated embodiments, the gateway terminal(s) 110 communicate with the satellite(s) 105 using Ku-band frequencies (12-18 GHz). Other implementations can use other suitable frequency bands. In some implementations, the gateway terminal(s) 110 convert signals between RF and baseband. Each gateway terminal 110 can be in communication with the GBBF system 130 via one or more high-speed links (e.g., fiber-optic links) to ensure minimal latency and high data throughput to support real-time beamforming.

The gateway terminal(s) 110 are in communication with the one or more satellites 105. Each satellite 105 can operate as a relay node. In some implementations, each satellite 105 has a bent-pipe architecture that receives, frequency converts, and amplifies signals without onboard processing. Each satellite 105 can be a geostationary Earth orbit (GEO) satellite or a non-geostationary orbit (NGSO) satellite (e.g., low Earth orbit (LEO), medium Earth orbit (MEO), etc.). Each satellite 105 produces multiple beams 120 using advanced phased-array antennas, which allow electronic beam steering and shaping. The beamforming is controlled by the GBBF system 130 (on the ground), which adjusts the phase and amplitude of the signals for each antenna element to direct the beams precisely to target geographical areas, optimizing coverage and capacity.

The multiple beams 120 formed by the satellite(s) 105 define coverage areas. User terminals 115 in those coverage areas can communicate with the satellite(s) 105 via the corresponding beams 120. The user terminals 115 can include any suitable end-user devices, such as smartphones, tablets, or IoT devices, adapted for satellite communication. In some implementations, as illustrated, the user terminals 115 communication with one or more satellites 105 using S-band (2-4 GHz) frequencies. Other implementations can use any other suitable frequency bands.

The GBBF system 130 performs digital beamforming operations on the signals transmitted to and received from the satellites 105. By processing the baseband signals from the gateway terminals 110, the GBBF system 130 adjusts the beam patterns dynamically to respond to changes in traffic demand, environmental conditions, or other factors. The ground-based approach reduces the payload complexity and cost of the satellites 105 by offloading the computationally intensive beamforming to the terrestrial infrastructure. The GBBF system may utilize high-performance computing platforms, such as arrays of GPUs or specialized DSPs, to handle the massive parallel processing requirements of beamforming for multiple beams and tenants.

As illustrated, the GBBF system 130 is in communication with the MTIC 140, which serves as an intelligent bridge between the terrestrial 5G NR network portion and the satellite NTN portion of the communication system 100. As illustrated, the terrestrial 5G NR portion of the network supports multiple tenants 150. Each tenant 150 can be associated with its own satellite radio access network (SRAN 155). One implementation has three SRANs 155 associated with three tenants 150. Another implementation has N SRANs 155 associated with N tenants 150, where N is an integer greater than 1 (i.e., at least 2). Although a particular network operator can theoretically be associated with multiple SRANs 155, or multiple network operators can theoretically share a single SRAN 155, the description herein assumes a one-to-one association between each tenant 150 and a corresponding SRAN 155 (e.g., N SRANs for N tenants 150).

Each SRAN 155 (illustrated as SRAN A 155-A, SRAN B 155-B, up to SRAN N 155-N) is a communication architecture that can include radio units (RUs), distributed units (DUs), and centralized units (CUs). The CUs are core processing entities within each SRAN 155 that handle non-real-time functions, such as session management, mobility management, and access control (e.g., including managing subscriber data and authentication); and they can manage overall coordination and control of RUs and DUs. The CUs interface with the core network 160 (e.g, the 5G core, or 5GC), thereby providing interconnection with external networks.

The DUs within each SRAN 155 are tasked with executing real-time processing functions, such as scheduling, beam management, and radio resource control. The DUs process signals received from the RUs, applying necessary adjustments and optimizations before forwarding them to the CUS (e.g., and vice versa). They can include high-performance digital signal processors (DSPs) or field-programmable gate arrays (FPGAs) to handle the computational demands of real-time processing, such as to ensure that the satellite beams are accurately directed and dynamically adjusted based on current traffic demands and environmental conditions.

The RUs are generally deployed closer to the air interface and tend to be responsible for radio signal transmission and reception. The RUs generally handle (or participate in) conversion between baseband and RF. For example, communications are received from the satellite(s) 105 in a satellite RF band and are converted to baseband for further processing by the DUs and CUs.

Although the SRANs 155 are illustrated as discrete blocks to the right of the MTIC 140, this is not intended to limit where SRAN 155 features are performed in the network. In some implementations, the GBBF system 130 and the MTIC 140 operate in baseband, and satellite 105 communications by gateway terminal(s) 110 are performed in RF. In such embodiments, the CUs and DUs (or at least a portion of the DU features), which operate in baseband, are implemented to the right of the GBBF system 130 and the MTIC 140 (in FIG. 1); and the RUs are deployed in the gateway terminals 110 to the left of the GBBF system 130 and the MTIC 140 and handle (or participate in) conversion between baseband and RF. In general, the MTIC 140 interfaces between the GBBF system 130 and the DUs of the different tenants 150. In some embodiments, some DU features are performed by the MTIC 140.

As illustrated, each tenant 150 communicates a tenant stream 157 to the MTIC 140. The MTIC 140 multiplexes the tenant streams 157 onto N beam links 135 (N is a positive integer) and communicates the beam links 135 to the GBBF system 130. Each of the N beam links 135 can carry data for up to M beams 120, so that the N*M total beams 120 are supported by the beam links 135. In one implementation, there are 16 beam links 135, each supporting data for up to 14 beams at a nominal symbol rate of 7.5 Mega-samples per second (Msps), so that 224 total beams (i.e., 16*14) are supported by the beam links 135. In such an implementation, the GBBF system 130 can effectively support concurrent beamforming of up to the 224 beams.

Each tenant 150 is in communication with the MTIC 140 via one or more high-speed links. In one implementation, each tenant 150 is in communication with the MTIC 140 via a pair of 100 Gigabit per second (Gbps) fiber links. The MTIC 140 is in communication with the GBBF system 130 via the N beam links 135. In one implementation, each beam link 135 is a 10 Gbps fiber link. For example, 16 such beam links 135 provides a total bandwidth of 160 Gbps between the MTIC 140 and the GBBF system 130.

As described herein, each SRAN 155 is configured according to a service profile associated with a corresponding tenant 150. Each service profile can be unique. Each service profile can define distinct data requirements, service level agreements (SLAs), configuration parameters, etc. As illustrated, each of the multiple SRANs 155 is in communication with the MTIC 140. In some embodiments such communications are according to the enhanced Common Public Radio Interface (eCPRI). eCPRI is a protocol optimized for fronthaul networks in 5G systems, which allows for efficient transport of user plane and control plane data over packet-based networks and supports high data rates with low latency. In some implementations, the communications between SRANs 155 and the MTIC 140 use eCPRI over IP/Ethernet.

To support operations of the GBBF system 130 with multiple tenants 150, embodiments include a resource manager 145 on the feeder-link side of the network. The resource manager 145 is responsible for managing and allocating resources to ensure efficient utilization of the satellite communication infrastructure while supporting multiple tenants 150. Embodiments of the resource manager 145 coordinate the placement of signals from different tenants 150 on different frequencies (i.e., for frequency-division multiplexing of beam 120 bandwidth), ensuring that these tenants 150 can share the same beams 120 without interference. In some embodiments, the resource manager 145 interacts with the tenants' 150 DUs and the GBBF system 130. By managing frequency assignments and beam allocations, the resource manager 145 can seek to optimize performance and signal integrity across the network. Implementation of the resource manager 145 can involve advanced software algorithms and hardware capable of real-time processing and decision-making to handle the dynamic nature of satellite communications and multiple tenant 150 service profiles.

In some embodiments, support for operations of the GBBF system 130 with multiple tenants 150 further includes one or more calibration Earth stations (not shown) deployed on the user-link side of the network. The calibration Earth stations can provide calibration data that fine-tunes the beamforming parameters, ensuring that the beams are accurately directed towards the intended user terminals 115. The calibration Earth stations work by continuously monitoring the signals and providing feedback to the GBBF system 130, allowing it to adjust the beamforming weights and other parameters to seek optimal signal quality and coverage. In some implementations, the calibration Earth stations are in communication with the GBBF system 130 and/or the resource manager 145 to facilitate the exchange of calibration data and adjustments. The implementation of calibration Earth stations can involve deploying high-precision measurement equipment and communication links that can provide real-time feedback to the GBBF system 130.

Multi-tenant support, as used herein, involves supporting multiple tenants 150 sharing the bandwidth of one or more beams 120 based on a frequency-division multiplexing scheme. This implies that at least some beam streams use less than the maximum beam 120 bandwidth. For example, each beam in a 5G NR NTN deployment can be allocated 5 MHz of bandwidth. If a 5 MHz stream is assigned to a beam 120, the stream will consume all the bandwidth of the beam 120. The maximum nominal beam bandwidth supported by the GBBF system 130 is represented herein as BBW. As described below, there may be architectures in which the maximum beam bandwidth supported by the satellite 105 is different from (e.g., greater than) BBW.

Embodiments described herein support multiple stream types. In some embodiments, a first stream type is a wideband (WB) stream, a second stream type is a narrow-band (NB) stream, and a third stream type is a very-narrow-band (VNB) stream. The WB stream consumes the entire BBW. The NB and VNB streams are configured so that at least one NB stream and at least one VNB stream can fit within the BBW. In one implementation, the BBW is 5 MHz, the WB stream is a 5 MHz stream to generally support 5G NR/NTN applications, the NB stream is a 3 MHz stream to support 5G NB NR/NTN applications (e.g., user terminals 115 that can only support up to 3 MHz), and the VNB stream is a 200 kHz stream to support narrowband Internet-of-Things (NB-IoT) applications and the like. In such an implementation, any given 5 MHz beam can support a single tenant 150 sending a WB stream; or multiple tenants 150 where no more than one is sending a NB stream and the rest are sending VNB streams.

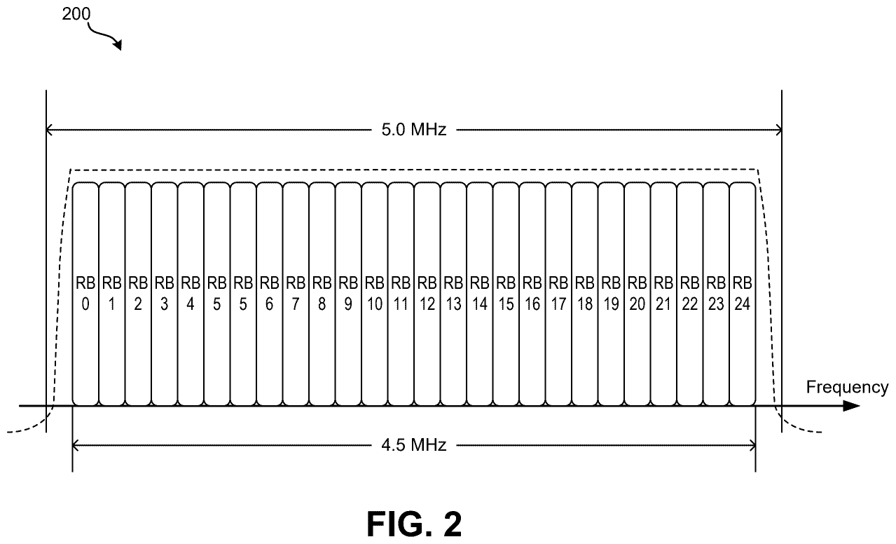

For added clarity, FIG. 2 shows an example of a resource block allocation 200 for a wideband stream type. A resource block (RB) is a unit of resource allocation in the frequency domain. In 5G NR, each RB typically spans 12 sub-carriers, and the sub-carrier spacing (SCS) determines the spacing between adjacent sub-carriers within the RBs. The example allocation 200 assumes that each RB consumes 180 kHz of bandwidth with a 15 kHz SCS (i.e., 180 kHz/12 sub-carriers=15 kHz SCS). As illustrated, the WB stream is allocated 25 RBs, which is equivalent to 4.5 MHz of bandwidth (i.e., 25*180 kHz=4.5 MHz). Accounting for guard bands to either side of the RBs, and because only full RBs are allocated (i.e., the allocation does not account for fractional RBs), only 25 RBs practically fit within the BBW of 5 MHz. As such, although only 4.5 MHz of RBs are allocated, this is considered practically as consuming the entire BBW.

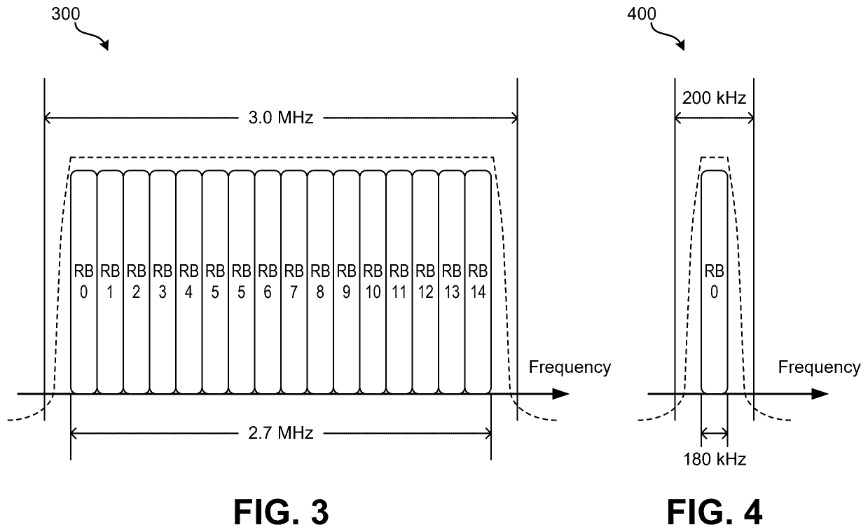

FIG. 3 shows an example of a resource block allocation 300 for a narrow-band stream type. As in FIG. 2, the example allocation 300 assumes that each RB consumes 180 kHz of bandwidth with a 15 kHz SCS (i.e., 180 kHz/12 sub-carriers=15 kHz SCS). As illustrated, the NB stream is allocated 15 RBs, which is equivalent to 2.7 MHz of bandwidth (i.e., 15*180 kHz=2.7 MHz). Accounting for guard bands to either side of the RBs, and because only full RBs are allocated, the 2.7 MHz of RBs practically consumes 3.0 MHz of beam bandwidth.

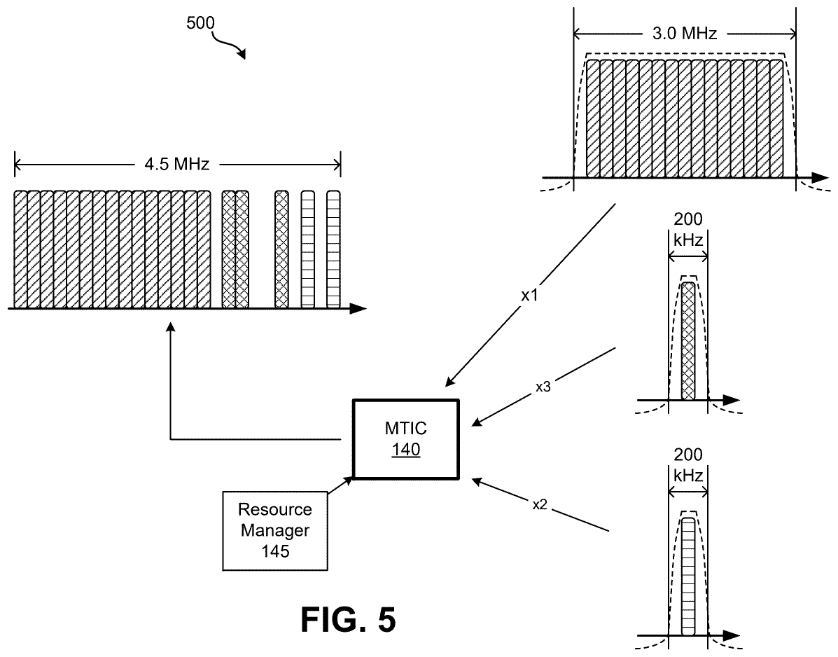

FIG. 4 shows an example of a resource block allocation 400 for a very-narrow-band stream type. As in FIGS. 2 and 3, the example allocation 400 assumes that each RB consumes 180 kHz of bandwidth with a 15 kHz SCS (i.e., 180 kHz/12 sub-carriers=15 kHz SCS). As illustrated, the VNB stream is allocated one RB, which is equivalent to 180 kHz of bandwidth. Accounting for guard bands to either side of the RB, and because only full RBs are allocated, the 180 kHz of RBs practically consumes 200 kHz of beam bandwidth.

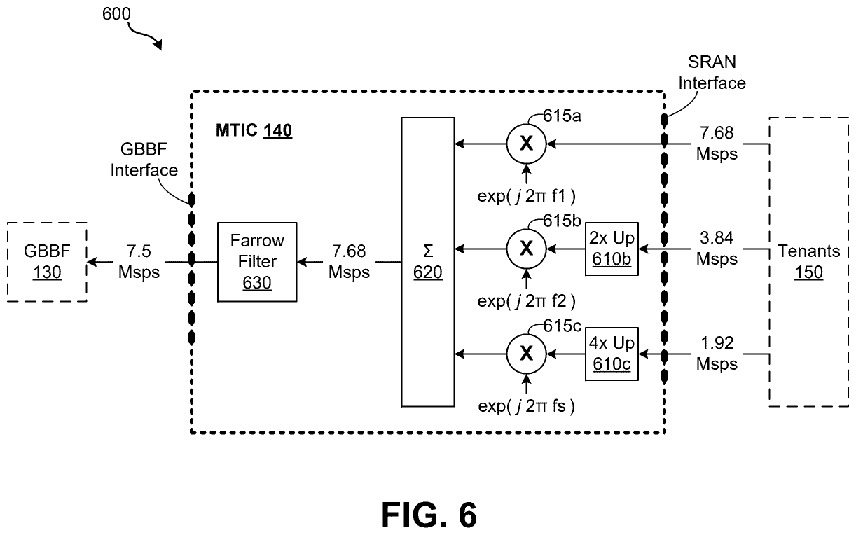

FIG. 5 shows an example of a multi-tenant resource block allocation 500 that includes multiple stream types facilitated by an MTIC 140. The stream types in FIG. 5 are based on those described in FIGS. 2-4. As illustrated, a first tenant sends a single NB stream to the MTIC 140. As described with reference to FIG. 3, the NB stream corresponds to 15 allocated RBs. A second tenant sends three VNB streams to the MTIC 140, and a third tenant sends two VNB streams to the MTIC 140. As described with reference to FIG. 4, each VNB stream corresponds to one allocated RB. As described with reference to FIG. 2, the full BBW corresponds to 25 RBs.

As illustrated, the resource manager 145 directs the MTIC 140 to allocate the appropriate number of RBs to each stream and to assign the RBs to respective frequencies within the BBW. In the illustrated case, the 6 streams only consume 80 percent of the BBW (i.e., 20 out of 25 allocatable RBs). The frequency assignments may or may not be contiguous. In the illustrated allocation, the WB stream RBs are allocated to a contiguous range of frequencies, and the NB and VNB streams are not.

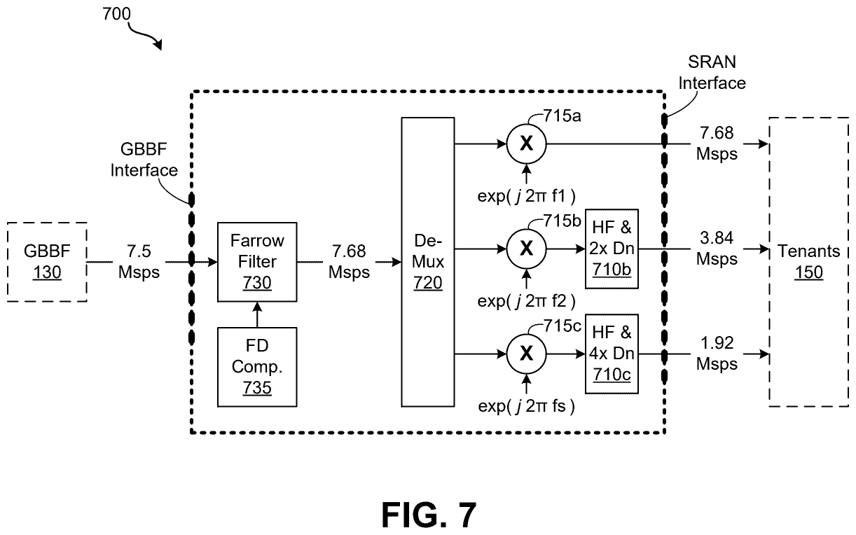

FIGS. 6 and 7 show forward-link and return-link portions, respectively, of a partial architecture having an illustrative MTIC 140 disposed between tenants 150 (e.g., DUs) and a GBBF system 130, according to embodiments described herein. In the illustrated architecture 600 of FIG. 6, it is assumed that the tenant 150 SRANs are configured so that the DUs perform substantially all low-level physical layer processing. For example, in the context of 5G NR, the 3rd Generation Partnership Project (3GPP) has defined functional splits (“split modes”) for dividing RAN functions between DUs and RUs. A commonly used split mode is “split mode 7.2,” which effectively divides functions between the DU and RU at the physical (PHY) layer of the network by splitting the PHY layer into higher PHY layer (“high-PHY”) and lower PHY layer (“low-PHY”) functions. High-PHY functions, such as channel coding, rate matching, and modulation, are handled by the DU. Low-PHY functions, such as resource element mapping, fast Fourier transform (FFT) processing, and cyclic prefix addition, are managed by the RU. At the DU-RU interface, frequency-domain IQ samples are transmitted from the DU to the RU. These samples can then be mapped onto resource blocks by the RU for transmission over the air interface.

In the illustrated architecture 600, it is assumed that the tenant 150 SRANs are configured so that the DUs perform substantially all low-level physical layer processing, such as according to “split mode 8.” Split mode 8 involves a more granular division of functions within the Medium Access Control (MAC) layer. In this configuration, the DU is responsible for higher-layer MAC functions, such as scheduling, HARQ (Hybrid Automatic Repeat Request) management, and RLC (Radio Link Control) protocol handling, and the RU manages lower-layer MAC functions, including multiplexing and demultiplexing of data streams, prioritization of data flows, etc. The DU effectively handles both high-PHY and low-PHY tasks. At the DU-RU interface in split mode 8, time-domain IQ samples are transmitted from the DU to the RU.

As described herein, the MTIC 140 is generally responsible for up-sampling and frequency multiplexing tenant streams 157 from different tenants 150 onto beam links 135 that are sent to the GBBF system 130. Use of split mode 8 can help to facilitate such operations of the MTIC 140 and of the resource manager 145 for several reasons. In general, centralizing PHY layer tasks in the DU can help to efficiently manage and optimize the processing required for multiple tenants 150, ensuring that the tenant streams 157 are properly prepared and standardized before they reach the MTIC 140. For example, by receiving data that has already undergone comprehensive PHY layer processing in the DU, the MTIC can focus on its core functions of aggregation and multiplexing without the added complexity of handling diverse PHY processing requirements from different tenants. Further, placing the PHY processing in the DU helps to ensure that that the data transmitted over the fronthaul link to the MTIC 140 is in a uniform and optimized format. This can help to reduce the volume of data that needs to be transmitted, as the data has already been encoded and modulated, thereby minimizing the bandwidth requirements and improving the overall efficiency of data transmission. Centralizing PHY processing in the DU also enhances the capabilities of the resource manager 145 by providing it with processed data that is ready for frequency allocation and beam management. This allows the resource manager 145 to more effectively coordinate the placement of signals from different tenants 150 on different (appropriate) frequencies, so that tenants 150 can share the same beams 120 without interference.

As illustrated, the MTIC 140 handles multiple stream types from multiple tenants 150. It is assumed that there are three stream types: a WB stream type, a NB stream type, and a VNB stream type. In the split mode 8 framework, time-domain IQ samples are provided to the MITC 140. In some implementations, a portion of the DU processing can be performed by processors of the MTIC 140. In such implementations, a front-end of the MTIC 140 may perform certain low-PHY tasks (e.g., FFT processing, channelization, etc.) essentially as part of the DU. Whether performed prior to the MTIC 140 or by a front-end portion of the MTIC 140, the illustrated features of the MTIC 140 are assumed to receive time-domain IQ samples.

The different stream types are sent at corresponding sample rates. Embodiments assume that there is a predefined (e.g., protocol-defined) full stream sample rate (SSR). For example, 5G NR standards support an SSR of 7.68 Msps. Any WB stream type is sent at the full SSR, and the NB and VNB streams are sent at lower sample rates. In the illustrated implementation, any WB stream type is sent at 7.68 Msps (e.g., the SSR), any NB stream type is sent at 3.84 Msps (e.g., half of the SSR), and any VNB stream type is sent at 1.92 Msps (e.g., one-quarter of the SSR). In one implementation, each stream type is configured to have a packet payload size of 320 IQ samples; and the eCPRI packet transmission rate can be every 1/24 ms for WB streams, every 1/12 ms for NB streams, and every 1/6 ms for VNB streams.

NB streams are received by the MTIC 140 by a 2× up-sampler 610b so they are effectively up-sampled from half of the SSR to the full SSR. VNB streams are received by the MTIC 140 by a 4× up-sampler 610c so they are effectively up-sampled from one-quarter of the SSR to the full SSR. The streams are passed to frequency converters 615, which assign each stream to an appropriate frequency (e.g., as directed by the resource manager 145). The streams are passed from the frequency converters 615 to a multiplexer, which effectively generates a single, frequency-division-multiplexed stream at the SSR having the different data from the different streams multiplexed together.

In general, embodiments assume that the SSR is different from the beam sample rate (BSR) used by the GBBF system 130 and further RF communications. For example, the illustrated architecture shows a BSR of 7.5 Msps. Embodiments of the MTIC 140 include a fractional delay filter convert the rate from the SSR to the BSR. In the illustrated embodiment, the fractional delay filter is implemented as a Farrow Filter 630. For example, the input to the Farrow Filter 630 is a stream of 16 bit ‘I’ and 16 bit ‘Q’ samples at 7.68 Msps, and the output from the Farrow Filter 630 is a stream of 16 bit ‘I’ and 16 bit ‘Q’ samples at 7.5 Msps.

Turning to FIG. 7, the illustrated architecture 700 is assumed to operate with the DUs perform substantially all low-level physical layer processing, such as according to split mode 8. In the return direction, the MTIC 140 is generally responsible for down-sampling and frequency demultiplexing tenant streams 157 from different tenants 150 from beam links 135 that are received from the GBBF system 130. Use of split mode 8 can help to facilitate such operations of the MTIC 140 and of the resource manager 145 for at least the same reasons as described above.

In the return-link scenario, signals transmitted from user terminals 115 are received by the satellite 105 and relayed to the GBBF system 130. The GBBF system 130 receives the return-link signals and forwards them to the MTIC 140 for further processing. Upon receiving the signals from the GBBF system 130, the MTIC 140 first processes them through a fractional delay filter, implemented as a Farrow filter 730. In some embodiments, the Farrow filter 730 is implemented in substantially the same manner as the Farrow filter 600 of FIG. 6. The Farrow filter 730 converts the BSR used by the GBBF system 130 (e.g., 7.5 Msps) to the SSR (e.g., 7.68 Msps).

The output from the Farrow filter 730 is passed to a demultiplexer 720, which effectively separates the combined frequency-division multiplexed signal into multiple streams at the SSR. These streams contain different data corresponding to multiple tenants 150 and can include various stream types. The demultiplexed streams are subsequently directed to frequency converters 715, which shift each stream from its FDM frequency to a baseband frequency. As in FIG. 6, the architecture 700 of FIG. 7 assumes the same three stream types with the same corresponding sample rates. Depending on the stream type, each frequency converted stream is either passed through to the appropriate tenant 150, or down-converted and passed to the appropriate tenant 150. For example, NB streams are passed through a 2× down-sampler 710b, down-sampling them from the full SSR to half of the SSR; and the VNB streams are passed through a 4× down-sampler 710c, down-sampling them from the full SSR to one-quarter of the SSR. After down-sampling, these different stream types are sent from the MTIC 140 to the respective tenants 150 at their corresponding sample rates.

In both the forward and return directions, GBBF relies on precise synchronization. In embodiments described herein, effective GBBF involves maintaining this precise synchronization even with frequency multiplexing of multiple tenants' 150 streams, with symbol rate changes, etc. One synchronization concern is the Doppler effect, which arises in satellite communication systems due to the relative motion between the satellite and ground-based stations. For example, referring to FIG. 1, the satellite 105 is moving relative to the Earth, and it therefore moving relative to ground stations, such as gateway terminal 110. This relative movement leads to changes in the frequency and phase of the signals received at the ground stations. Practically, such shifts in frequency usually do not align with an integer multiple of the system's base frequency, and these fractional changes, or “fractional Doppler” (FD) effects, can disrupt the timing and synchronization of the communication system.

In the return link, user terminals 115 transmit signals that are received by the satellite 105 and are relayed to the MTIC 140 via the gateway terminal 110 and the GBBF system 130. Upon reception, the signals exhibit Doppler-induced frequency and phase shifts due to the satellite's motion. As illustrated in FIG. 7, embodiments of the MTIC 140 include a FD compensator 735 to help maintain proper synchronization and signal integrity by compensating for fractional Doppler shifts before further processing. The FD compensator 735 calculates the fractional Doppler shift affecting the received signals using precise ephemeris data of the satellite 105, which provides information about the satellite's exact position and velocity at any given time. Based on the ephemeris data, the FD compensator 735 determines the exact amount of frequency and timing correction needed to counteract the Doppler-induced distortions.

Embodiments of the FD compensator 735 are integrated into the signal processing chain within the MTIC 140, situated between the reception of the signals from the GBBF system and the Farrow filter 730, or otherwise integrated with the Farrow filter 730. For example, the FD compensator 735 communicates directly with the Farrow filter 730, providing it with adjustment parameters to correct the sampling rate discrepancies caused by the Doppler effect. By adjusting the interpolation factors within the Farrow filter 730 based on the computed fractional Doppler shift, the system can effectively restore the signals to their intended state at the SSR from the BSR.

Embodiments of the FD compensator 735 also interface with the resource manager 145 and/or the calibration Earth stations to obtain real-time ephemeris data and other relevant system parameters. This collaboration helps to ensure that the compensation applied is both accurate and up-to-date, accounting for any changes in the satellite's trajectory or velocity. By dynamically adjusting to the satellite's movements, the FD compensator 735 can maintain synchronization across all tenant streams 157. The multiplexing of tenant streams 157 in the forward direction and demultiplexing of tenant streams 157 in the return direction can rely on maintaining such synchronization across all tenant streams 157.

Embodiments include additional synchronization features. In some embodiments, at the GBBF system 130, a GPS-locked clock is employed on the forward link to provide a highly accurate and stable timing reference. GPS signals offer precise time synchronization within nanoseconds. By locking the GBBF system's 130 clock to GPS time, the transmitted signals can be precisely timed and phased, ensuring that the beams formed are correctly aligned with the moving satellite 105 and the intended user terminals 115.

On the return link, embodiments of the GBBF system 130 can use a Doppler-embedded GPS-locked pilot signal. This pilot signal, synchronized with GPS time, includes embedded information about the Doppler shifts expected due to the satellite's motion. By sending this pilot signal, the system provides the receiving components with data to compensate for Doppler-induced frequency shifts. This compensation helps ensure accurate demodulation and decoding of the received signals to maintain the integrity and reliability of the communication link.

Embodiments of the MTIC 140 can also use a GPS-locked clock. One implementation uses a precise 10 MHz frequency reference and a 1 Pulse Per Second (PPS) timing signal. The 10 MHz clock accurately aligns all frequency-related processes within the MTIC 140, and the 1 PPS signal is used for precise timing synchronization. As described above, the MTIC 140 can also use ephemeris-based Doppler information to calculate and predict and compensate for Doppler shifts. These MTIC 140 synchronization features can help to ensure that MTIC 140 processes are properly synchronized when interfacing with both the tenants 150 and the GBBF system 130.

Embodiments of the SRANs 155 can also incorporate GPS-locked clocks to maintain synchronization across the network. The GPS synchronization ensures that all SRANs 155 share a common and precise time and frequency reference, minimizing timing discrepancies that could lead to signal degradation or loss. The SRANs 155 can also access ephemeris data to monitor the satellite's trajectory and velocity, thereby being able to predict Doppler effects on the uplink and downlink signals and apply corresponding frequency and timing adjustments.

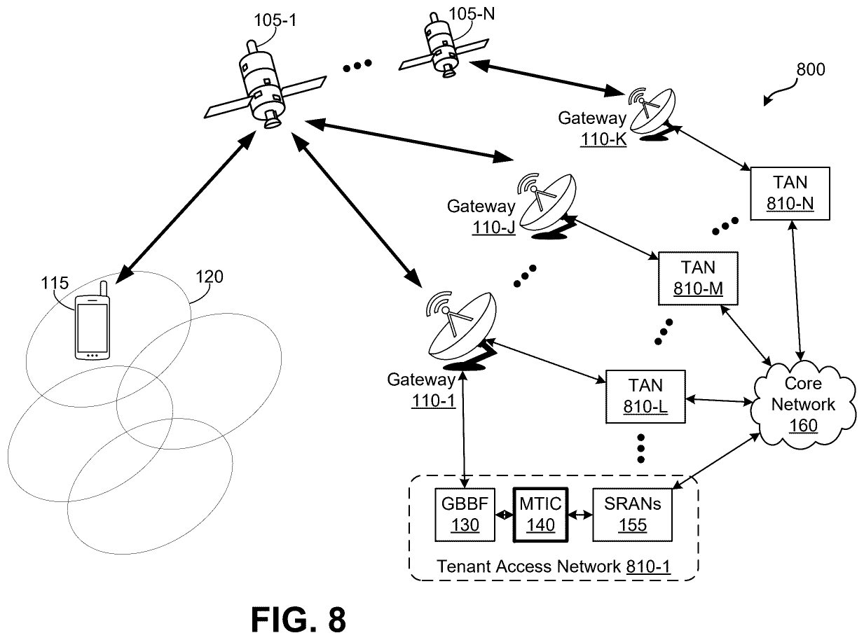

FIG. 8 shows an illustrative communication system 800 including a terrestrial network with a multi-beam satellite-based non-terrestrial network (NTN) extension, according to embodiments described herein. The system 800 shows several options for alternative embodiments of the system 100 of FIG. 1. For clarity, FIG. 8 groups together each instance of the GBBF system 130, MTIC 140, and SRANs 155 as a tenant access network (TAN) 810. The alternative embodiments illustrated by FIG. 8 can include any suitable combination of two or more TANs 810, one or more gateway terminals 110, and one or more satellites 105. Each of the TANs 810 can be in communication with the same core network 160, or embodiments can include multiple core networks.

Each alternative embodiment can provide respective features. Some such features are common across all the alternatives. As one example, having multiple MTICs 140 can increase support of multiple tenants 150 with diverse requirements, as each MTIC 140 can be tailored to efficiently handle specific tenants or services. As another example, the multiple SRANs 155 in these configurations can be strategically deployed to maximize coverage and capacity. For example, in densely populated areas, multiple SRANs 155 can alleviate network congestion by serving different clusters of users or operating on different frequency bands; and in rural or remote areas, additional SRANs 155 can enhance signal strength and reliability, improving user experience.

One set of alternative embodiments includes two or more TANs 810 in communication with a single satellite 105 via a single gateway terminal 110. Such embodiments can achieve enhanced capacity, redundancy, and load balancing, such as my managing higher volumes of data traffic and serving a larger number of users simultaneously. For example, the multiple TANs 810 can allow for parallel processing of data streams to improve throughput and reduce latency, while the centralization of the gateway terminal 110 can simplify network management and reduce infrastructure costs.

Another set of alternative embodiments includes two or more TANs 810 each in communication with the same single satellite 105 via a respective one of two or more gateway terminals 110. Such embodiments can provide expanded geographic coverage and improved resilience. Multiple gateway terminals 110 positioned in different locations enable the network to provide services over a broader area, and/or can enhance reliability by providing redundancy, fail-over, etc.

Another set of alternative embodiments includes two or more TANs 810 each in communication with a respective one of two or more satellites 105 via a respective one of two or more gateway terminals 110. Such embodiments can provide more flexibility, capacity, and fault tolerance. For example, accessing multiple satellites 105 can allow the network to distribute traffic loads more effectively, avoid congestion, and offer seamless coverage even if one satellite 105 becomes unavailable. Such embodiments can also support advanced services, like satellite diversity, where signals can be transmitted or received from the most favorable satellite 105 based on factors like position, signal strength, or weather conditions.

In some embodiments, a single resource manager 145 (not shown) can be centrally deployed to service multiple TANs 810. For example, each resource manager 145 can service all TANs 810 or a corresponding subset of the TANs 810. Multiple GBBF systems 130 in the multiple TANs 810 perform beamforming tasks independently but coordinate through a common resource manager 145 to prevent interference and optimize beam allocation.

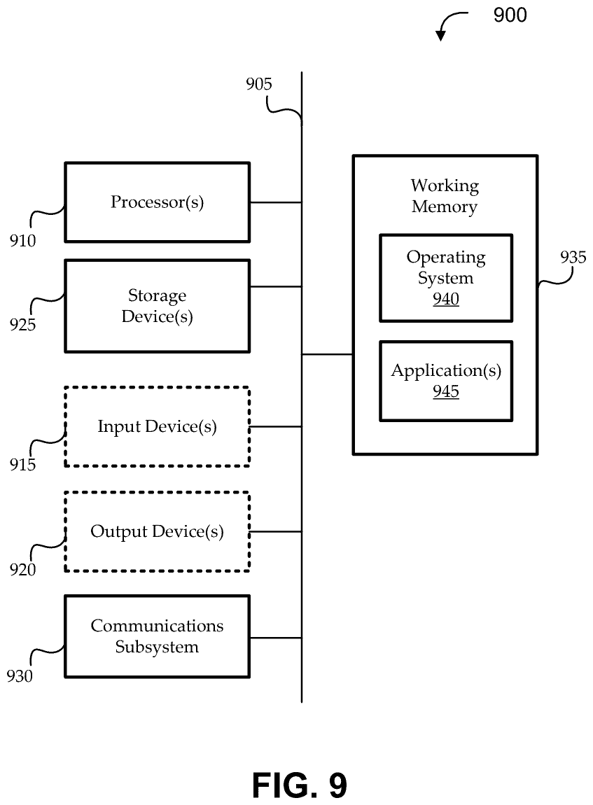

In some embodiments, components of the MTIC 140 are implemented by a computational system. FIG. 9 provides a schematic illustration of an embodiment of a computational system 900 that can implement various system components and/or perform various steps of methods provided by various embodiments. FIG. 9 is meant only to provide a generalized illustration of various components, any or all of which may be utilized as appropriate. FIG. 9, therefore, broadly illustrates how individual system elements may be implemented in a relatively separated or relatively more integrated manner.

The computational system 900 is shown including hardware elements that can be electrically coupled via a bus 905 (or may otherwise be in communication, as appropriate). The hardware elements may include one or more processors 910, including, without limitation, one or more general-purpose processors and/or one or more special-purpose processors (such as digital signal processing chips, graphics acceleration processors, video decoders, and/or the like). Optionally, embodiments of the computational system 900 can include one or more input devices 915, and/or one or more output devices 920. The input devices 915 can include user input devices (e.g., a mouse, a keyboard, remote control, touchscreen interfaces, audio interfaces, video interfaces, and/or the like) and/or machine input devices (e.g., computer-to-computer interfaces, such as wired and/or wireless input data ports). Similarly, the output devices 920 can include user output devices (e.g., display devices, printers, and/or the like), and/or machine input devices (e.g., computer-to-computer interfaces, such as wired and/or wireless output data ports).

The computational system 900 may further include (and/or be in communication with) one or more non-transitory storage devices 925, which can comprise, without limitation, local and/or network accessible storage, and/or can include, without limitation, a disk drive, a drive array, an optical storage device, a solid-state storage device, such as a random-access memory (“RAM”), and/or a read-only memory (“ROM”), which can be programmable, flash-updateable and/or the like. Such storage devices may be configured to implement any appropriate data stores, including, without limitation, various file systems, database structures, and/or the like. In some embodiments, the storage devices 925 include memory for storing encryption keys, encrypted data, and/or other information used by embodiments to implement features described herein.

The computational system 900 can also include a communications subsystem 930, which can include, without limitation, a modem, a network card (wireless or wired), an infrared communication device, a wireless communication device, and/or a chipset (such as a Bluetooth™ device, an 802.11 device, a WiFi device, a WiMax device, cellular communication device, etc.), and/or the like. Depending on where in the network the computational system 900 is deployed, the communications subsystem 930 can include any suitable hardware and/or software components for communicating with other salient portions of the network. In some implementations, the communications subsystem 930 includes components for interfacing with a satellite network (e.g., with GBBF system 130), with SRANs 155, and/or with terrestrial backhaul networks and/or other networks.

The computational system 900 further includes a working memory 935, which can include a RAM or ROM device, as described herein. The computational system 900 also can include software elements, shown as currently being located within the working memory 935, including an operating system 940, device drivers, executable libraries, and/or other code, such as one or more application programs 945, which may include computer programs provided by various embodiments, and/or may be designed to implement methods, and/or configure systems, provided by other embodiments, as described herein. Merely by way of example, one or more procedures described with respect to the method(s) discussed herein can be implemented as code and/or instructions executable by a computer (and/or a processor within a computer); in an aspect, then, such code and/or instructions can be used to configure and/or adapt a general-purpose computer (or other device) to perform one or more operations in accordance with the described methods. As illustrated, the operating system 940 and the working memory 935 can be used in conjunction with the one or more processors 910 to implement the some or all of the features of the MTIC 140.

A set of these instructions and/or codes can be stored on a non-transitory (or non-transient) computer-readable storage medium, such as the non-transitory storage device(s) 925 described above. In some cases, the storage medium can be incorporated within a computer system, such as computational system 900. In other embodiments, the storage medium can be separate from a computer system (e.g., a removable medium, such as a compact disc), and/or provided in an installation package, such that the storage medium can be used to program, configure, and/or adapt a general-purpose computer with the instructions/code stored thereon. These instructions can take the form of executable code, which is executable by the computational system 900 and/or can take the form of source and/or installable code, which, upon compilation and/or installation on the computational system 900 (e.g., using any of a variety of generally available compilers, installation programs, compression/decompression utilities, etc.), then takes the form of executable code.

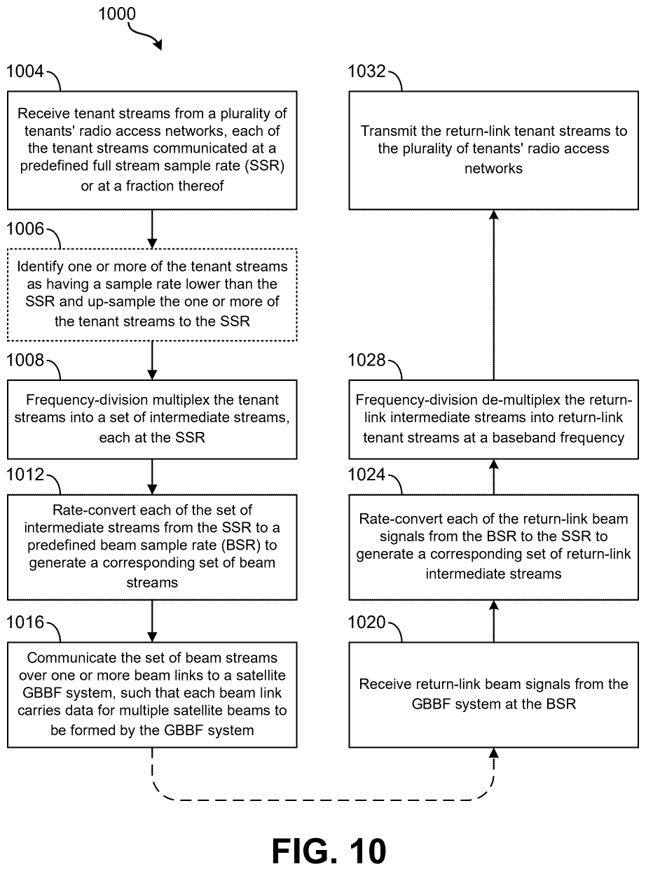

In some embodiments, the computational system 900 implements a portion of a system for communicating a data signal in a wireless communication network, as described herein. In some embodiments, the non-transitory storage device(s) 925 can have instructions stored thereon, which, when executed, cause the processor(s) 910 to perform steps of the method 1000 of FIG. 10.

It will be apparent to those skilled in the art that substantial variations may be made in accordance with specific requirements. For example, customized hardware can also be used, and/or particular elements can be implemented in hardware, software (including portable software, such as applets, etc.), or both. Further, connection to other computing devices, such as network input/output devices, may be employed.

As mentioned above, in one aspect, some embodiments may employ a computer system (such as the computational system 900) to perform methods in accordance with various embodiments of the invention. According to a set of embodiments, some or all of the procedures of such methods are performed by the computational system 900 in response to processor 910 executing one or more sequences of one or more instructions (which can be incorporated into the operating system 940 and/or other code, such as an application program 945) contained in the working memory 935. Such instructions may be read into the working memory 935 from another computer-readable medium, such as one or more of the non-transitory storage device(s) 925. Merely by way of example, execution of the sequences of instructions contained in the working memory 935 can cause the processor(s) 910 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computational system 900, various computer-readable media can be involved in providing instructions/code to processor(s) 910 for execution and/or can be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 925. Volatile media include, without limitation, dynamic memory, such as the working memory 935. Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 910 for execution. Merely by way of example, the instructions may initially be carried on a disk of a remote computer. The remote computer can load the instructions into its dynamic memory and send the instructions as signals over a transmission medium to be received and/or executed by the computational system 900. The communications subsystem 930 (and/or components thereof) generally will receive signals, and the bus 905 then can carry the signals (and/or the data, instructions, etc., carried by the signals) to the working memory 935, from which the processor(s) 910 retrieves and executes the instructions. The instructions received by the working memory 935 may optionally be stored on a non-transitory storage device 925 either before or after execution by the processor(s) 910.

FIG. 10 shows a flow diagram of a method 1000 for facilitating communications between a plurality of tenants of a terrestrial network and a satellite ground-based beamforming (GBBF) system, according to embodiments described herein. Embodiments of the method 1000 begin at stage 1004 by receiving tenant streams from a plurality of tenants' radio access networks, each of the tenant streams communicated at a predefined full stream sample rate (SSR) or at a fraction thereof.

At stage 1008, embodiments can frequency-division multiplex the tenant streams into a set of intermediate streams, each at the SSR. In some embodiments, the frequency-division multiplexing in stage 1008 includes frequency converting each tenant stream to a respective carrier frequency within a full beam bandwidth (BBW) supported by the GBBF system.

Some embodiments, at stage 1006 (prior to stage 1008), can identify one or more of the tenant streams as having a sample rate lower than the SSR and can up-sample the one or more of the tenant streams to the SSR prior to the frequency-division multiplexing at stage 1008. For example, at least a first tenant stream of the tenant streams is a narrow-band (NB) stream communicated at a predefined NB sample rate that is 1/J of the SSR;
at least a second tenant stream of the tenant streams is a VNB stream communicated at a predefined VNB sample rate that is 1/K of the SSR (J and K are positive integers); a sum of the NB sample rate and the VNB sample rate is less or equal to than the SSR; and the up-sampling comprises up-sampling the first tenant stream by a factor of J and up-sampling the second tenant stream by a factor of K.

At stage 1012, embodiments can rate-convert each of the set of intermediate streams from the SSR to a predefined beam sample rate (BSR) to generate a corresponding set of beam streams. In some embodiments, the rate-converting is performed by a fractional delay filter, such as a Farrow filter.

At stage 1016, embodiments can communicate the set of beam streams over one or more beam links to a satellite GBBF system, such that each beam link carries data for multiple satellite beams to be formed by the GBBF system.

Some embodiments can also include return-link processing. At stage 1020, such embodiments can receive return-link beam signals from the GBBF system at the BSR. At stage 1024, such embodiments can rate-convert each of the return-link beam signals from the BSR to the SSR to generate a corresponding set of return-link intermediate streams. In some such embodiments, the rate-converting at stage 1024 includes: computing fractional Doppler shifts affecting the return-link beam signals based on ephemeris data of a satellite that relayed the return-link beam signals to the GBBF system; and adjusting interpolation factors in a fractional delay filter based on the computed fractional Doppler shifts to compensate for the fractional Doppler shifts. At stage 1028, such embodiments can frequency-division de-multiplex the return-link intermediate streams into return-link tenant streams at a baseband frequency. At stage 1032, such embodiments can transmit the return-link tenant streams to the plurality of tenants' radio access networks.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for facilitating communications between a plurality of tenants of a terrestrial network and a satellite ground-based beamforming (GBBF) system, the method comprising:
receiving tenant streams from a plurality of tenants' radio access networks, each of the tenant streams communicated at a predefined full stream sample rate (SSR) or at a fraction thereof;
frequency-division multiplexing the tenant streams into a set of intermediate streams, each at the SSR;
rate-converting each of the set of intermediate streams from the SSR to a predefined beam sample rate (BSR) to generate a corresponding set of beam streams; and
communicating the set of beam streams over one or more beam links to a satellite GBBF system, such that each beam link carries data for multiple satellite beams to be formed by the GBBF system.

2. The method of claim 1, wherein the frequency-division multiplexing comprises:
frequency converting each tenant stream to a respective carrier frequency within a full beam bandwidth (BBW) supported by the GBBF system.

3. The method of claim 1, wherein the rate-converting is by a fractional delay filter.

4. The method of claim 1, further comprising:
identifying one or more of the tenant streams as having a sample rate lower than the SSR; and
up-sampling the one or more of the tenant streams to the SSR prior to the frequency-division multiplexing.

5. The method of claim 4, wherein:
at least a first tenant stream of the tenant streams is a narrow-band (NB) stream communicated at a predefined NB sample rate that is 1/J of the SSR;
at least a second tenant stream of the tenant streams is a VNB stream communicated at a predefined VNB sample rate that is 1/K of the SSR;
J and K are positive integers;
a sum of the NB sample rate and the VNB sample rate is less or equal to than the SSR; and
the up-sampling comprises up-sampling the first tenant stream by a factor of J and up-sampling the second tenant stream by a factor of K.

6. The method of claim 1, further comprising:
receiving return-link beam signals from the GBBF system at the BSR;
rate-converting each of the return-link beam signals from the BSR to the SSR to generate a corresponding set of return-link intermediate streams;
frequency-division de-multiplexing the return-link intermediate streams into return-link tenant streams at a baseband frequency; and
transmitting the return-link tenant streams to the plurality of tenants' radio access networks.

7. The method of claim 6, wherein the rate-converting each of the return-link beam signals comprises:
computing fractional Doppler shifts affecting the return-link beam signals based on ephemeris data of a satellite that relayed the return-link beam signals to the GBBF system; and
adjusting interpolation factors in a fractional delay filter based on the computed fractional Doppler shifts to compensate for the fractional Doppler shifts.

8. A multi-tenant interface controller (MTIC) comprising:
a satellite radio access network (SRAN) interface for receiving tenant streams from a plurality of SRANs associated with a plurality of tenants, each tenant stream being one of a plurality of stream types including at least a first stream type having a first sample rate and a second stream type having a second sample rate;
a set of up-converters to up-convert the plurality of tenant streams to a predefined full stream sample rate (SSR);
a set of frequency converters to convert each of the tenant streams to a respective carrier frequency within a full beam bandwidth (BBW) supported by a satellite ground-based beamforming (GBBF) system;
a multiplexer to multiplex the plurality of tenant streams, after the up-converting and the frequency converting, onto one or more intermediate streams at the SSR;
a rate-converter to rate-convert each of the one or more intermediate streams from the SSR to a predefined beam sample rate (BSR) to generate a corresponding one or more beam streams; and
a GBBF interface to communicate the one or more beam streams over one or more beam links to the satellite GBBF system, such that each beam link carries data for multiple satellite beams to be formed by the GBBF system.

9. The MTIC of claim 8, further comprising:
a global positioning satellite (GPS) locked clock synchronized with GPS locked clocks at the GBBF system and at the plurality of SRANs.

10. The MTIC of claim 8, wherein the rate-converter comprises a Farrow filter.

11. The MTIC of claim 8, wherein the SRAN interface is an enhanced Common Public Radio Interface (eCPRI) modified to support a 3rd Generation Partnership Project (3GPP) fifth-generation (5G) New Radio (NR) fronthaul split mode 8 payload.

12. The MTIC of claim 8, wherein the GBBF interface is further to receive return-link beam signals from the GBBF system at the BSR, and further comprising:
a return rate converter to rate-convert each of the return-link beam signals from the BSR to the SSR to generate a corresponding set of return-link intermediate streams;
a de-multiplexer to de-multiplex the set of return-link intermediate streams into the return-link tenant streams;
a set of return frequency converters to frequency convert the plurality of return-link tenant streams to a baseband frequency;
a set of down-converters to down-convert each the plurality of return-link tenant streams to a sample rate associated with a stream type of the return-link tenant stream,
wherein the SRAN interface is further to transmit the return-link tenant streams to the plurality of tenants' radio access networks subsequent to the frequency converting and down-converting.

13. The MTIC of claim 12, further comprising:
a fractional Doppler (FD) compensator configured to:
compute fractional Doppler shifts affecting the return-link beam signals based on ephemeris data of a satellite that relayed the return-link beam signals to the GBBF system; and
adjust interpolation factors in the return rate converter based on the computed fractional Doppler shifts to compensate for the fractional Doppler shifts.

14. A multi-tenant interface controller (MTIC) for facilitating communications between a plurality of tenants of a terrestrial network and a satellite ground-based beamforming (GBBF) system, the MTIC comprising:
one or more processors;
a non-transitory, processor-readable memory having a set of instructions stored thereon which, when executed, cause the one or more processors to perform steps comprising:
receiving tenant streams from a plurality of tenants' radio access networks, each of the tenant streams communicated at a predefined full stream sample rate (SSR) or at a fraction thereof;
frequency-division multiplexing the tenant streams into a set of intermediate streams, each at the SSR;
rate-converting each of the set of intermediate streams from the SSR to a predefined beam sample rate (BSR) to generate a corresponding set of beam streams; and
communicating the set of beam streams over one or more beam links to a satellite GBBF system, such that each beam link carries data for multiple satellite beams to be formed by the GBBF system.

15. The MTIC of claim 14, wherein the frequency-division multiplexing comprises:
frequency converting each tenant stream to a respective carrier frequency within a full beam bandwidth (BBW) supported by the GBBF system.

16. The MTIC of claim 14, wherein the rate-converting is by a fractional delay filter.

17. The MTIC of claim 14, wherein the instructions further comprise:
identifying one or more of the tenant streams as having a sample rate lower than the SSR; and
up-sampling the one or more of the tenant streams to the SSR prior to the frequency-division multiplexing.

18. The MTIC of claim 17, wherein:
at least a first tenant stream of the tenant streams is a narrow-band (NB) stream communicated at a predefined NB sample rate that is 1/J of the SSR;
at least a second tenant stream of the tenant streams is a VNB stream communicated at a predefined VNB sample rate that is 1/K of the SSR;
J and K are positive integers;
a sum of the NB sample rate and the VNB sample rate is less or equal to than the SSR; and
the up-sampling comprises up-sampling the first tenant stream by a factor of J and up-sampling the second tenant stream by a factor of K.

19. The MTIC of claim 14, wherein the instructions further comprise:
receiving return-link beam signals from the GBBF system at the BSR;
rate-converting each of the return-link beam signals from the BSR to the SSR to generate a corresponding set of return-link intermediate streams;
frequency-division de-multiplexing the return-link intermediate streams into return-link tenant streams at a baseband frequency; and
transmitting the return-link tenant streams to the plurality of tenants' radio access networks.

20. The MTIC of claim 19, wherein the rate-converting each of the return-link beam signals comprises:
computing fractional Doppler shifts affecting the return-link beam signals based on ephemeris data of a satellite that relayed the return-link beam signals to the GBBF system; and
adjusting interpolation factors in a fractional delay filter based on the computed fractional Doppler shifts to compensate for the fractional Doppler shifts.
